(19) United States
(12) Patent Application Publication
(10) Pub. No.: US 2023/0182159 A1
(43) Pub. Date: Jun. 15, 2023

(54) Decorative Defect Re-Basecoating System for Cans and other Cylindrical Containers

(71) Applicants: Kevin Gillest, Frasier, CO (US); Michael Calahan, Arvada, CA (US)

(72) Inventors: Kevin Gillest, Frasier, CO (US); Michael Calahan, Arvada, CA (US)

(21) Appl. No.: 17/838,269

(22) Filed: Jun. 13, 2022

Related U.S. Application Data
(63) Continuation-in-part of application No. 16/696,990, filed on Nov. 26, 2019.
Application No. 16/696,990 is a continuation of application No. 15/858,292, filed on Dec. 29, 2017, now Pat. No. 10,518,285.
Application No. 15/858,292 is a continuation of application No. 14/484,229, filed on Sep. 11, 2014, now Pat. No. 9,889,460.

(51) Int. Cl. B05B 13/02; B05B 13/04; B05B 7/06; B05D 7/22

(52) U.S. Cl. CPC B05B 13/0228; B05B 7/061; B05B 13/0278; B05B 13/0426; B05D 7/225; B05D 7/227

(57) ABSTRACT

A quick, practical and economical method, machine and system for re-basecoating cans which have necks, flanges but also have basecoat and or decoration defects. The cans may pass by a corona /plasma treatment which removes lubricant. A main starwheel will carry the cans to a can body coating application device (such as a high durometer resilient roller), then to a can neck coating application device (similar but shaped for the neck/flange of the can). The main starwheel will carry the cans through an induction tunnel in which cans have an electrical current induced, thereby curing the cans before the cans are removed by an outfeed device and placed onto an outfeed conveyor. Hold down chucks hold the cans from the top (in addition to vacuum chucks holding the cans from the bottom) and cover the top of the cans so that the new coating material does not enter.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but reserves all copyright rights whatsoever. 37 CFR 1.71(d).

### CROSS REFERENCE TO RELATED APPLICATIONS

This application is a continuation-in-part of previously filed and co-pending U.S. Application 16/696,990, filed Nov. 26, 2019, which is a continuation-in-part of U.S. Application 15/858,292 filed Dec. 29, 2017 (now patent number 10,518,285) which is itself a continuation of U.S. Application 14/484,229, filed Sep. 11, 2014 (now patent number 9,889,460), for which documents and cases the priority and benefit are hereby claimed.

### FIELD OF THE INVENTION

This invention relates generally to can spraying / coating machinery but very specifically to recoating/rebasecoating/decorating/overvarnishing of cans which had previously had decoration defects.

### STATEMENT REGARDING FEDERALLY FUNDED RESEARCH

This invention was not made under contract with an agency of the U.S. Government, nor by any agency of the U.S. Government.

### BACKGROUND OF THE INVENTION

The traditional process of can manufacture requires that the can, before or after necking and flanging, be basecoated and / or decorated with coatings on the exterior of the can. (FIG. 12 is a PRIOR ART simplified representation of a can, upside down on a mandrel, being coated. The mandrel prevents coating from entering.) Since the necking usually entails an application of lubricant, the basecoated / decorated cans are lubricated, necked, and flanged.

Necking makes the open end of the can smaller in diameter (see reference numbers 10 and 12 of FIG. 4), so the mandrel it originally sat on can no longer fit into it. Any straight mandrel small enough to fit through the neck will allow the can to rattle around, making redecoration impossible: after necking and flanging, the can is just no longer a convenient shape for further decoration, overvarnish, basecoating, rebasecoating and other similar actions. For example the can side walls (the straight vertical portion of the can) can no longer be easily supported by a mandrel.

For many years industry leaders have discussed trying to find a means to cover a decorated, lubricated, necked, flanged can with another layer of decoration, despite the complex shape and lubrication. This becomes necessary because of manufacturing flaws which sometimes occur in a run of cans. Worse, due to the nature of the production process, problems are often found when the flawed cans have already been palletized in large numbers. For this reason, the can maker would like to re-basecoat the cans, but as discussed since the cans are lubricated, necked and flanged, they can no longer fit onto a standard mandrel.

This problem is known in the industry, but no solution has been found which is both quick and inexpensive.

As a result, the cans must not only be sold for scrap aluminum prices, a substantial loss, but in addition the cans must be depalletized before being scrapped/crushed/bailed. Thus, labor costs are incurred as well.

At the present time, 100% of cans with decoration flaws are scrapped, there is no production facility in the world which has an economical solution to this problem, nor an economical method of re-basecoating. The cans cannot easily be handled due to being necked, they cannot easily be basecoated without allowing coating to enter the necked open end of the can, handling uncured cans results in build ups of coating which not only make a mess but cause flaws in later cans and can eventually even impair the operation of the machinery, and the cans are lubricated during the original necking and the lubricant presents a problem for any hypothetical newly applied re-basecoat.

Thus, this problem has long been known in the industry and yet has no known practical solution until the present invention.

It would be preferable to provide an economical method, machine, and system of re-basecoating cans with decoration defects.

It would be preferable to provide an economical and fast method, machine, and system of coating cans which have already been necked and flanged, for example, cans which have decorating flaws.

It would yet further be preferable to provide a practical and economical method, machine and system for re-basecoating cans repeatedly, so that multiple coats may be applied and darker decorative defects (i.e., designs with darker colors such as black predominating) could be quickly covered with sufficient layers to allow for a lighter shade of base-coating as required for coverage of the decoration.

### SUMMARY OF THE INVENTION

### General Summary

The present invention teaches a quick, practical and economical method for re-basecoating cans with design defects in basecoat or decoration, despite the cans being necked and flanged. In addition, the present invention teaches a core machine and an overall system for re-basecoating necked, flanged cans with design defects.

The invention teaches that a depalletizer may move the cans from a pallet to an infeed conveyor, where the cans may pass by a corona or plasma treatment which removes the lubricant. Thereafter the cans reach an infeed starwheel which removes the cans from the conveyor and places them into the pockets (and onto the vacuum chucks) of a main starwheel.

The main starwheel may advantageously have a horizontal plane of rotation, as this assists with the re-basecoating process of the invention. In addition, the main starwheel will carry the cans first to a can body coating application device (such as a high durometer resilient roller), then to a can neck coating application device (of a similar material but shaped for the neck/flange of the can). After that, the cans may have a new coating on them, but will still require at least partial curing, so the main starwheel will carry the cans through an induction tunnel before the cans are removed by an outfeed device and placed onto an outfeed conveyor. The curing is necessary to allow handling of the cans.

The main starwheel also has hold down chucks which hold the can from the top (in addition to the vacuum chucks holding the can from the bottom). This is in marked contrast to known coating systems which use a cylindrical mandrel inside of an un-necked, un-flanged, un-lubricated can. The hold down chucks also cover the top of the can so that the new coating material does not enter the can - this was also previously unknown, as in traditional systems the mandrel substantially occupied the volume of the can and so covering it was un-needed.

The main starwheel may convey a given can past the re-basecoating rollers more than once in order to apply multiple coats. Additional sets of coating devices may also be employed.

Spray guns may in alternative embodiments be used in place of rollers, though rollers are presently preferred.

A second curing step may be added: the first curing step in the curing tunnel beside the main starwheel need only cure the outermost layer of new coating material so that the cans can be handled without be smeared, without spreading coating all over the machinery following the coating rollers, and so forth.

The rollers may be shrouded to prevent coating material from flying off during use.

A vacuum plate may be employed as the outfeed device, or an outfeed starwheel.

### SUMMARY IN REFERENCE TO CLAIMS

It is therefore another aspect, advantage, objective and embodiment of the invention, in addition to those discussed previously, to provide a decoration defect re-basecoating system for cans which are already necked and decorated, comprising: an infeed conveyor carrying such cans;
a plasma spray dimensioned and configured to remove lubricant from such neck of such cans as the infeed conveyor carries such cans;
an infeed starwheel dimensioned and configured to remove such cans from the infeed conveyor;
a main starwheel, dimensioned and configured to rotate and to move such cans from the infeed starwheel to the main starwheel and to secure them in place on a plurality of vacuum chucks and then to rotate such cans under a plurality of hold down chucks, each hold down chuck having thereon a can cover, the can covers operative to cover the open end of a respective first one of such cans whereby a coating may not enter such cans;
the main starwheel further operative to rotate each of such cans to a body coating application device and a neck coating application device, then to an induction tunnel having at least one induction coil and then to an outfeed device;
the body coating application device operative to apply the coating to such can body, the neck coating application device operative to apply the coating to such can neck; the outfeed device operative to remove such cans from the main starwheel and place them on an exit conveyor.

It is therefore another aspect, advantage, objective and embodiment of the invention, in addition to those discussed previously, to provide a decoration defect re-basecoating system wherein the main starwheel further comprises: a main starwheel plane of rotation which is horizontal.

It is therefore another aspect, advantage, objective and embodiment of the invention, in addition to those discussed previously, to provide a decoration defect re-basecoating system wherein the body coating application is a first roller.

It is therefore another aspect, advantage, objective and embodiment of the invention, in addition to those discussed previously, to provide a decoration defect re-basecoating system wherein the neck coating application device is a second roller.

It is therefore another aspect, advantage, objective and embodiment of the invention, in addition to those discussed previously, to provide a decoration defect re-basecoating system wherein the outfeed further comprises: an outfeed starwheel.

It is therefore another aspect, advantage, objective and embodiment of the invention, in addition to those discussed previously, to provide a decoration defect re-basecoating system wherein the induction tunnel further comprises: a second induction coil.

It is therefore another aspect, advantage, objective and embodiment of the invention, in addition to those discussed previously, to provide a decoration defect re-basecoating system wherein the induction coil and the second induction coil induce an electrical current in such can whereby the coating is at least partially cured.

It is therefore another aspect, advantage, objective and embodiment of the invention, in addition to those discussed previously, to provide a decoration defect re-basecoating system wherein the body coating application device is a first spray gun.

It is therefore another aspect, advantage, objective and embodiment of the invention, in addition to those discussed previously, to provide a decoration defect re-basecoating system wherein the neck coating application device is a second spray gun.

It is therefore another aspect, advantage, objective and embodiment of the invention, in addition to those discussed previously, to provide a decoration defect re-basecoating system wherein the outfeed further comprises: an outfeed vacuum plate.

It is therefore another aspect, advantage, objective and embodiment of the invention, in addition to those discussed previously, to provide a decoration defect re-basecoating system wherein the main starwheel is operative to rotate such cans more than one time through the body coating application device and the neck coating application, whereby more than one layer of the coating may be applied to such cans.

It is therefore another aspect, advantage, objective and embodiment of the invention, in addition to those discussed previously, to provide a decoration defect re-basecoating system further comprising:

a second body coating application device and a second neck coating application device, whereby more than one layer of the coating may be applied to such cans.

It is therefore another aspect, advantage, objective and embodiment of the invention, in addition to those discussed previously, to provide a decoration defect re-basecoating machine for cans which are already necked and decorated, comprising:
a main starwheel, dimensioned and configured to rotate and to move such cans and to secure them in place on a plurality of vacuum chucks and then to rotate such cans under a plurality of hold down chucks, each hold down chuck having thereon a can cover, the can covers operative to cover the open end of a respective first one of such cans whereby a coating may not enter such cans;
the main starwheel further operative to rotate each of such cans to a body coating application device and a neck coating application device;
the body coating application device operative to apply the coating to such can body, the neck coating application device operative to apply the coating to such can neck.

It is therefore another aspect, advantage, objective and embodiment of the invention, in addition to those discussed previously, to provide a decoration defect re-basecoating method of re-basecoating defectively decorated cans which have already been necked and basecoated, but in which cans the original basecoat has been found to be defective, the method comprising the steps of:
a. Depalletizing defectively decorated cans;
b. Removing lubricant from the necks of the defectively decorated cans;
c. Securing the defectively decorated cans to a main starwheel having a horizontal plane of rotation;
d. Covering the openings of the defectively decorated cans so that a coating may not enter;
e. Applying at least one new basecoat to the defectively decorated cans in at least one part of the defectively decorated cans, the one part of the defectively decorated can consisting of one member selected from the list comprising:
   i. the body of the defectively decorated cans,
   ii. the neck of the defectively decorated cans,
   iii. combinations thereof,
f. Using an induction coil to at least partially cure the defectively decorated cans which have been re-basecoated;
g. Palletizing the defectively decorated cans which have been re-basecoated.

It is therefore another aspect, advantage, objective and embodiment of the invention, in addition to those discussed previously, to provide a decoration defect re-basecoating method comprising the steps of:

method of re-basecoating defectively basecoated or decorated cans of claim 15, wherein the step of applying at least one new basecoat to the defectively decorated cans is carried out by rolling the basecoat onto the cans.

It is therefore another aspect, advantage, objective and embodiment of the invention, in addition to those discussed previously, to provide a decoration defect re-basecoating method wherein the step of removing lubricant from the necks of the defectively decorated cans is carried out using a plasma spray dimensioned and configured to remove lubricant from such neck of such cans as the infeed conveyor carries such cans.

It is therefore another aspect, advantage, objective and embodiment of the invention, in addition to those discussed previously, to provide a decoration defect re-basecoating method wherein the step of applying at least one new basecoat to the defectively decorated cans is carried out using a coating formulated to adhere to basecoat, ink, and overvarnish.

### BRIEF DESCRIPTION OF THE DRAWINGS

FIG. 1 is an orthogonal planform top view of the deco defect re-basecoating system of the invention.

FIG. 2 is a perspective front right elevational view of a first presently preferred embodiment and best mode now contemplated of the deco defect re-basecoating system of the invention, including the partial-cut-away detail view later found in FIG. 4.

FIG. 3 is a perspective rear right elevational view of the first embodiment of the deco defect re-basecoating system of the invention.

FIG. 4 is a partial-cut-away detail view of the coating rollers of the first embodiment of the invention.

FIG. 5 is a perspective front right elevational view of an alternative embodiment of the deco defect re-basecoating system of the invention, showing an outfeed vacuum plate.

FIG. 6 is a perspective rear right elevational view of an alternative embodiment of the deco defect re-basecoating system of the invention, showing both the outfeed vacuum plate and including the partial-cut-away detail view later found in FIG. 7 (induction tunnel).

FIG. 7 shows greater detail of the vacuum chucks and induction tunnel for partial or complete curing.

FIG. 8 is a perspective front right elevational view of an alternative embodiment of the deco defect re-basecoating system of the invention, showing the use of spray guns instead of rollers as coating application devices.

FIG. 9 is a perspective rear left elevational view of an alternative embodiment of the deco defect re-basecoating system of the invention, showing both the spray guns for application devices and also a detail view thereof.

FIG. 10 is a detail view of the plasma spray of the invention.

FIG. 11 is a detail view of the spray guns of the alternative embodiment.

FIG. 12 is a view of a PRIOR ART un-necked can on a mandrel while being coated.

### INDEX TO REFERENCE NUMERALS

| | |
|---|---|
| Can (bottom end upward) | 4 |
| Mandrel | 6 |
| Un-necked open end (mouth) of can | 8 |
| Open end of can | 10 |
| Can neck | 12 |
| Necked can | 14 |
| Decoration defect re-basecoating system | 100 |
| Infeed conveyor | 102 |
| Plasma spray | 104 |
| Infeed starwheel | 106 |
| Main starwheel | 108 |
| Vacuum chucks | 112 |
| Hold down chucks | 114 |
| Can covers | 116 |
| Induction tunnel | 118 |
| First induction coil | 120 |
| Exit conveyor | 122 |
| Body application roller | 124 |
| Body application spray gun | 126′ |
| Neck application roller | 128 |
| Neck application spray gun | 130′ |
| Outfeed vacuum plate | 132′ |
| Track | 133′ |
| Outfeed starwheel | 134 |
| Second induction coils | 136 |
| Body roller cover | 138 |
| Neck roller cover | 140 |
| Infeed conveyor drive | 142 |
| Exit conveyor drive | 144 |
| Machine body | 146 |
| Plasma spray emitter | 148 a |

### DETAILED DESCRIPTION

### Glossary

In the appended claims, the word “such” refers to work pieces which the invention’s claimed limitations and elements operate upon but which are not themselves parts of the claim invention. In particular, “such cans” refers to cans or other open ended cylindrical containers (in further particularity, beverage cans), “such necks of such cans”, “such necks”, etc, refers to the narrower necked portion of such cans, “such body of such cans” and similar terms refers to the relatively straight walls of such cans below the neck.

Cans are not claimed in the appended claims, only the deco defect re-basecoating system of the present invention.

The terms tangent point of the body and tangent point of the neck refers to the place on such cans where the neck and body join at a relative angle.

It will be noticed that the claims refer only to necked cans: prior art relevant to un-necked cans will simply not work on necked cans, except by being retroactively changed according to the learning of the present invention.

### End Glossary

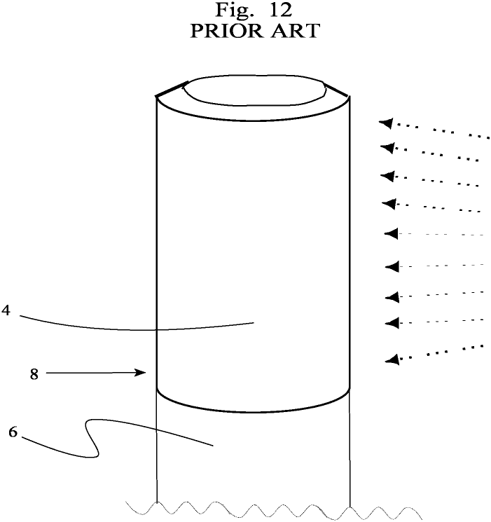

FIG. 12 is a view of a PRIOR ART un-necked can on a mandrel while being coated. The un-necked can 4 is seen with its bottom end upward on mandrel 6. The opening of the mouth of the can (the open end of the can) is filled by the mandrel 6.

The un-necked part 8 is straight, so coating (for example from an unseen spray gun) can be applied easily. The un-necked can 4 can easily be handled on the mandrel and can easily be removed (for example with a puff of air) without disturbing the decoration or the basecoat, since the body side walls are straight.

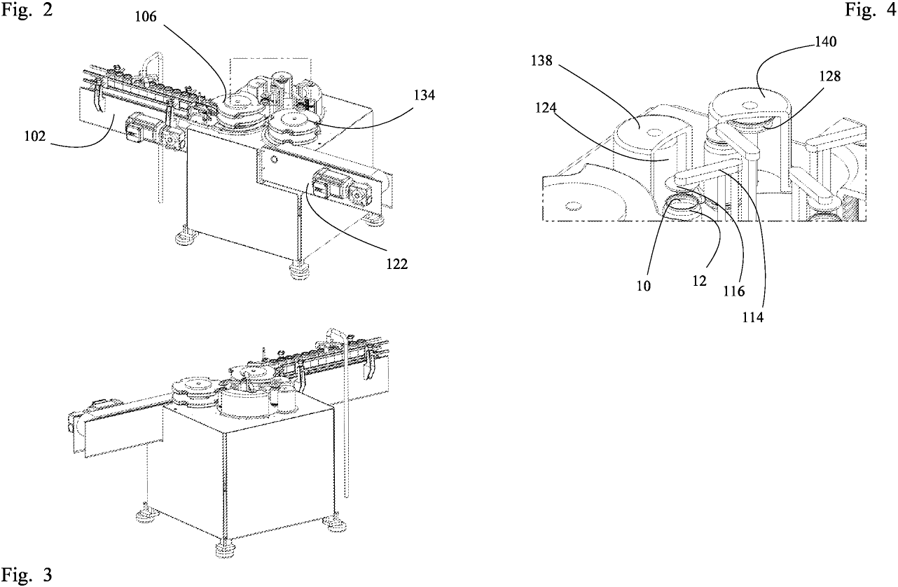

However, soon after this step the can will be lubricated, necked and flanged, resulting in the shape seen in the necked cans 14 seen in all other FIGS. 2 through 11, for example FIG. 10. After that necking, handling of the can 14 becomes entirely different from handling of an un-necked can 4. In particular, any methods or machinery for basecoating will no longer be applicable as the can 14 cannot be handled in the same manners as can 4.

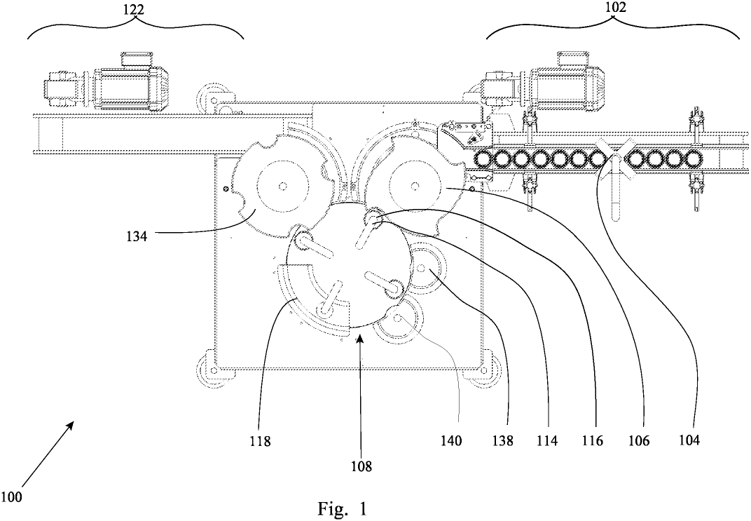

FIG. 1 is an orthogonal planform top view of the deco defect re-basecoating system of the invention, with the deco defect re-basecoating machine at its heart. Decoration defect re-basecoating system 100 has an infeed conveyor 102. This conveyor will carry cans past a plasma spray 104, in this case, an overhanging set of arms with four plasma spray emitters arranged and properly elevated so that the plasma removes the lubrication from the neck of each can as it passes.

Infeed starwheel 106 then removes the cans from the infeed conveyor 102 and placing the cans 14 on the main starwheel 108 which carries four hold down chucks 114. Vacuum chucks 112 (not visible in FIG. 1 but depicted in FIG. 7) secure the bottom end of the can 14 at the dome of the can (which is on the bottom). Vacuum chucks 112 and hold down chucks 114 between them secure the can 14 without covering any of the sidewall or the necked area. This leaves the sidewall and necked area visible and accessible to the coating application devices discussed in reference to later drawings.

Can covers 116 carried by the hold down chucks 114 serve a dual purpose as the operative portion of the hold down chucks, securing the flanged necks, but also covering the open end of the can to prevent coating from entering during later steps.

Induction tunnel 118 (discussed in greater detail in FIG. 7) will at least partially cure the necked and re-basecoated cans 14, in particular, curing at least the outermost layer so that the cans can once again be handled normally in relationship to the coating being safe to handle (although note that the cans still require handling based on being necked).

Outfeed starwheel 134 then removes the cans 14 from the main starwheel 108 and places them onto the exit conveyor 122. After this step the cans 14 may go to a further curing device or go to another similar machine for another coating, or may be decorated, etc. One advantageous outcome would be repalletizing of the cans 14, now free of deco defects.

FIG. 2 is a perspective front right elevational view of a first presently preferred embodiment and best mode now contemplated of the deco defect re-basecoating system of the invention, including the partial-cut-away detail view depicted in FIG. 4 (a partial-cut-away detail view of the coating rollers). FIG. 3 is a perspective rear right elevational view of the first embodiment of the deco defect re-basecoating system of the invention.

The infeed conveyor 102 and outfeed conveyor 122 are much as previously seen, while the infeed starwheel 106 and the outfeed starwheel 134 may be seen in greater detail to have two levels, and different shapes.

In FIG. 4, the open end 10 of can 14 and the can neck 12 may be easily seen, with the can cover 116 on the hold down chuck 114 seen slightly raised above the flanged neck 12. In later positions of the cans 14 (see in the same FIG. 4) the can cover 116 and hold down chuck 114 may be seen to have descended to the can (or the can to have been raised by the invisible vacuum chuck 112 underneath) so that the can cover 116 seals the open end 10 against the entry of coating.

Sealed, the can 14 passes by body coating application roller 124, and as they mutually roll against one another the entire vertical can body wall is coated up to the tangent point (where the vertical can body wall meets the neck). Cover 138 prevents the rapidly spinning roller 124 from spreading the coating material in all directions. Thereafter the main starwheel 108 carries the can 14, now partially re-basecoated, past the neck application roller 128, which is an entirely different shape from the body application roller 124. Neck application roller 128 is contoured to generally match a can neck shape, and in alternative embodiments may even be contoured to match a specific run of cans. It may also project further toward the can 14 than the body roller, since the neck is relatively speaking recessed. The neck roller 128 and neck 12 may roller against one another until the entire neck is re-basecoated. Neck roller cover 140 serves a function similar to body roller cover 138.

Both rollers may be made of a high durometer resilient material allowing them to conform to the can 14 shape. This is important as the can is NOT internally supported by a mandrel, as previously discussed, unlike the prior art shown in FIG. 12.

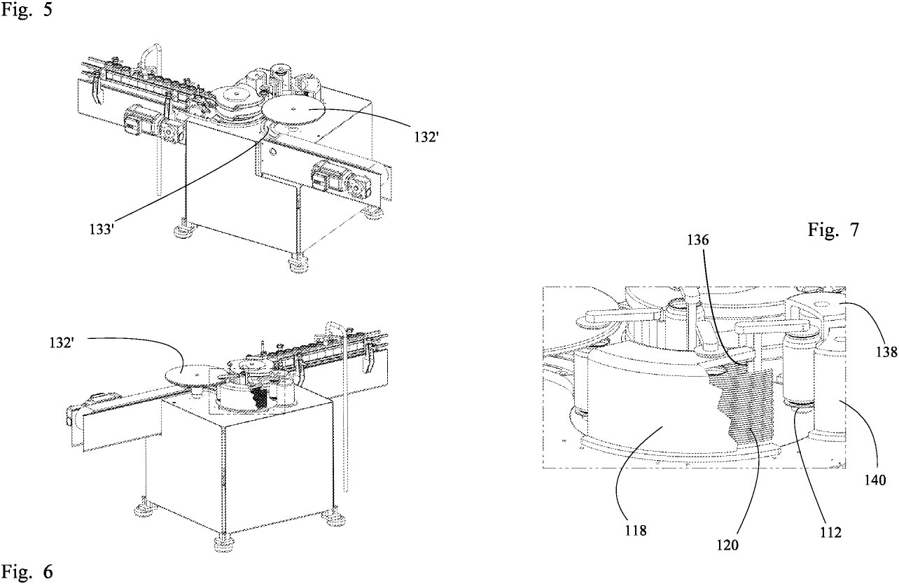

FIG. 5 is a perspective front right elevational view of an alternative embodiment of the deco defect re-basecoating system of the invention, showing an outfeed vacuum plate instead of a starwheel, while FIG. 6 is a perspective rear right elevational view of an alternative embodiment of the deco defect re-basecoating system of the invention, showing both the outfeed vacuum plate and including the partial-cut-away detail view later found in FIG. 7 (depicting the induction tunnel).

Outfeed vacuum plate 132′ replaces the outfeed starwheel in this alternative embodiment, by exerting a negative pressure differential against the open end 10 of the can, thus adhering the can to the plate 132′ above. Track 133′ serves to guide the bottom end of the can 14.

Induction tunnel 118 may be seen to have a central semi-circular area through which the can 14 is carried by the starwheel 108. The can 14 thus passes between two induction coils 120 and 136. The electrical current begins the process of curing the new basecoat on the can. As noted previously, it is important to cure at least the outside layer of the new basecoat so that the can may be handled like a normal necked can.

This view also shows in greater detail the vacuum chuck 112 on which the can rides, secured between the vacuum chuck below and the hold down chuck / can cover 114 / 116 above.

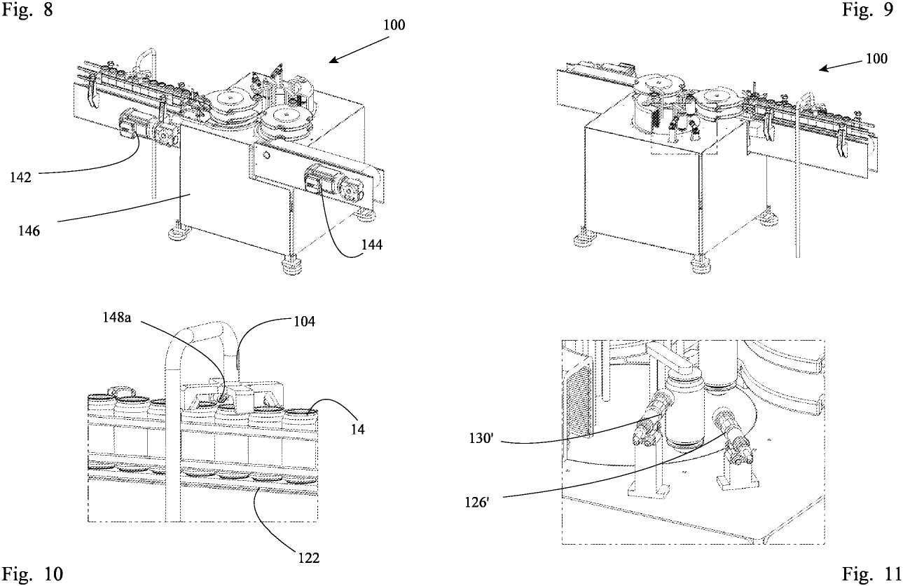

FIG. 8 is a perspective front right elevational view of another alternative embodiment of the deco defect re-basecoating system of the invention, showing the use of spray guns instead of rollers as coating application devices. FIG. 9 is a perspective rear left elevational view of the second alternative embodiment of the deco defect re-basecoating system of the invention, showing both the spray guns for application devices and also a detail view thereof. FIG. 10 is a detail view of the plasma spray of the invention, and FIG. 11 is a detail view of the spray guns of the alternative embodiment.

Body application spray gun 126′ replaces body roller 124 and obviates the necessity for shroud 138 over the roller 124, while neck spray gun 130′ replaces the neck roller 128 and its shroud 140.

Spray guns are standard in the industry for applying base coats to cans without defects, and even to apply coatings internally. The industry is familiar with their use and maintenance. However, it is an alternative embodiment in the invention for various reasons. Overspray may be a problem for other places than just the can, the spray gun may not coat properly with the desired coating and so on.

Infeed conveyor drive 142 and exit conveyor drive 144 are of course controlled and synchronized with the main starwheel 108 drive (unseen), for example by a digital controller. Note that either drive may in fact also drive the main starwheel 108, for example, drive 144 can easily drive the operations of the main device by means of a power take off from the idler pulley wheel under the outfeed starwheel, however, the preferred embodiment uses three drives, with the main drive inside of the machine body 146.

FIG. 10 shows the plasma spray emitter 148a on the plasma / corona discharge 104. In this embodiment there may be 4 emitters on a single plasma / corona spray 104. As infeed conveyor 122 carries the cans underneath, the upper / necked end is freed from lubrication and any contaminants adhering to the lubricant.

It will be understood that the step of recoating a can, with basecoat, decoration, ink, etc, will require a basecoat formulated to adhere to basecoat, ink, and overvarnish. This is because at the present time, basecoat, decoration, ink, overvarnish and so forth are formulated to adhere to bare aluminum, not to overvarnish or the like. It is estimated to be 95% likely that standard formulations will not adhere properly when used in the present invention.

The disclosure is provided to render practicable the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

What is claimed is:

1. A decoration defect re-basecoating system for cans which are already necked and decorated, comprising:
an infeed conveyor carrying such cans;
a plasma spray dimensioned and configured to remove lubricant from such neck of such cans as the infeed conveyor carries such cans;
an infeed starwheel dimensioned and configured to remove such cans from the infeed conveyor;
a main starwheel, dimensioned and configured to rotate and to move such cans from the infeed starwheel to the main starwheel and to secure them in place on a plurality of vacuum chucks and then to rotate such cans under a plurality of hold down chucks, each hold down chuck having thereon a can cover, the can covers operative to cover the end of a respective first one of such cans whereby a coating may not enter such cans;
the main starwheel further operative to rotate each of such cans to a body coating application device and a neck coating application device, then to an induction tunnel having at least one induction coil and then to an outfeed device;
the body coating application device operative to apply the coating to such can body, the neck coating application device operative to apply the coating to such can neck;
the outfeed device operative to remove such cans from the main starwheel and place them on an exit conveyor.

2. The decoration defect re-basecoating system of claim 1, wherein the main starwheel further comprises:
a main starwheel plane of rotation which is horizontal.

3. The decoration defect re-basecoating system of claim 2, wherein the body coating application is a first roller.

4. The decoration defect re-basecoating system of claim 3, wherein the neck coating application device is a second roller.

5. The decoration defect re-basecoating system of claim 4, wherein the outfeed further comprises: an outfeed starwheel.

6. The decoration defect re-basecoating system of claim 5, wherein the induction tunnel further comprises: a second induction coil.

7. The decoration defect re-basecoating system of claim 7, wherein the induction coil and the second induction coil induce an electrical current in such can whereby the coating is at least partially cured.

8. The decoration defect re-basecoating system of claim 1, wherein the body coating application device is a first spray gun.

9. The decoration defect re-basecoating system of claim 8, wherein the neck coating application device is a second spray gun.

10. The decoration defect re-basecoating system of claim 1, wherein the outfeed further comprises: an outfeed vacuum plate.

11. The decoration defect re-basecoating system of claim 1, wherein the main starwheel is operative to rotate such cans more than one time through the body coating application device and the neck coating application, whereby more than one layer of the coating may be applied to such cans.

12. The decoration defect re-basecoating system of claim 1, further comprising:
a second body coating application device and a second neck coating application device, whereby more than one layer of the coating may be applied to such cans.

13. A decoration defect re-basecoating machine for cans which are already necked and decorated, comprising:
a main starwheel, dimensioned and configured to rotate and to move such cans and to secure them in place on a plurality of vacuum chucks and then to rotate such cans under a plurality of hold down chucks, each hold down chuck having thereon a can cover, the can covers operative to cover the open end of a respective first one of such cans whereby a coating may not enter such cans;
the main starwheel further operative to rotate each of such cans to a body coating application device and a neck coating application device;
the body coating application device operative to apply the coating to such can body, the neck coating application device operative to apply the coating to such can neck.

14. The decoration defect re-basecoating system of claim 1, wherein the main starwheel further comprises:
a main starwheel plane of rotation which is vertical.

15. A method of re-basecoating defectively basecoated or decorated cans which have already been necked and basecoated, but in which cans the original basecoat or decoration has been found to be defective, the method comprising the steps of:
a. Depalletizing defectively decorated cans;
b. Removing lubricant from the necks of the defectively decorated cans;
c. Securing the defectively decorated cans to a main starwheel having a horizontal plane of rotation;
d. Covering the openings of the defectively decorated cans so that a coating may not enter;
e. Applying at least one new basecoat to the defectively decorated cans in at least one part of the defectively decorated cans, the one part of the defectively decorated can consisting of one member selected from the list comprising:
i. the body of the defectively decorated cans,
ii. the neck of the defectively decorated cans,
iii. combinations thereof,
f. Using an induction coil to cure the defectively decorated cans which have been re-basecoated;
g. Palletizing the defectively decorated cans which have been re-basecoated.

16. The method of re-basecoating defectively basecoated or decorated cans of claim 15, wherein the step of applying at least one new basecoat to the defectively decorated cans is carried out by rolling the basecoat onto the cans.

17. The method of re-basecoating defectively basecoated or decorated cans of claim 16, wherein the step of removing lubricant from the necks of the defectively decorated cans is carried out using a plasma spray dimensioned and configured to remove lubricant from such neck of such cans as the infeed conveyor carries such cans.

18. The method of rebasecoating defectively basecoated or decorated cans of claim 17, wherein the step of applying at least one new basecoat to the defectively decorated cans is carried out using a coating formulated to adhere to basecoat, ink, and overvamish.
